(19) United States
(12) Patent Application Publication
(10) Pub. No.: US 2014/0192045 A1
(43) Pub. Date: Jul. 10, 2014

(54) METHOD AND APPARATUS FOR GENERATING THREE-DIMENSIONAL CARICATURE USING SHAPE AND TEXTURE OF FACE

(71) Applicant: Electronics and Telecommunications Research Institute, Daejeon (KR)

(72) Inventors: Bon Woo HWANG, Daejeon (KR); Kap Kee KIM, Daejeon (KR); Seong Jae LIM, Daejeon (KR); Seung Uk YOON, Bucheon (KR); Hye Ryeong JUN, Daejeon (KR); Bon Ki KOO, Daejeon (KR); Jin Sung CHOI, Daejeon (KR)

(21) Appl. No.: 14/147,773

(22) Filed: Jan. 6, 2014

(30) Foreign Application Priority Data
Jan. 8, 2013 (KR) 10-2013-0001902

(51) Int. Cl. G06T 15/04

(52) U.S. Cl. CPC G06T 15/04
USPC 345/419

(57) ABSTRACT

Provided is a method and apparatus for generating a three-dimensional (3D) caricature. The apparatus for generating a 3D caricature may include a 3D face data generation unit to generate 3D face data of a user corresponding to a shape and a texture of a face of the user, a 3D unique face model generation unit to generate a 3D unique face model using a shape and a texture of a unique face based on the 3D face data and a reference face, and a 3D caricature generation unit to generate a 3D caricature using the 3D unique face model and a caricature base face model.

### CROSS-REFERENCE TO RELATED APPLICATION(S)

This application claims the benefit under 35 U.S.C. §119(a) of Korean Patent Application No. 10-2013-0001902, filed on Jan. 8, 2013, in the Korean Intellectual Property Office, the entire disclosure of which is incorporated herein by reference for all purposes.

### BACKGROUND

1. Field

Exemplary embodiments relate to a method and apparatus for generating a three-dimensional (3D) caricature, and more particularly, to a method and apparatus that may generate a 3D caricature of a user using a shape and a texture of a face and provide the 3D caricature according to a desired intent of the user.

2. Description of Related Art

Generally, an automatic caricature generation system generates a caricature image by exaggerating or deforming a shape of a particular part of a face from a face photo image in two dimensions and by changing texture information. Recently, the automatic caricature generation system is evolving into a type of three-dimensional (3D) caricature generation using a face modeling technique. Here, the face modeling technique extracts face feature information through statistical analysis using face images of front and side views. Also, the face modeling technique extracts face feature point information using an active shape model method and deforms a basic 3D face model based on the extracted feature point information, thereby generating a 3D face model resembling a face of a user.

However, a conventional method using the face modeling technique does not reflect a trait inherent to a caricature because of not performing exaggeration or intentional deformation of a face. That is, the conventional method does not reflect artistic and unique aspects of a caricature, and just reflects 3D shape information of a face.

Also, studies have been conducted to enable an automatic caricature generation system to make a 3D caricature reflecting a trait intrinsic to a caricature by exaggerating a shape difference with a reference face template when an input face for generating a caricature is given. However, this method simply emphasizes the shape difference with the reference face, and does not reflect an artistic style realized through sensuous manipulation by an expert modeler.

### SUMMARY

An aspect of the present invention provides a method and apparatus for generating a three-dimensional (3D) caricature that may generate a 3D caricature reflecting a style of an expert modeler on a face of a user, so that 3D caricatures of various styles may be generated by effectively reflecting artistic and unique traits inherent to a caricature.

In one general aspect, there is provided an apparatus for generating a 3D caricature, the apparatus including a 3D face data generation unit to generate 3D face data of a user corresponding to a shape and a texture of a face of the user, a 3D unique face model generation unit to generate a 3D unique face model using a shape and a texture of a unique face based on the 3D face data and a reference face, and a 3D caricature generation unit to generate a 3D caricature using the 3D unique face model and a caricature base face model.

The 3D face data generation unit may generate the shape of the face based on a 3D position of the face using phase shifts of the face in structured light being projected, and may generate the texture of the face using an image of the face taken with diffused illumination without projecting the structured light.

The 3D face data generation unit may generate the shape of the face based on the 3D position of the face, using a triangulation method, from a correspondence relationship between at least one face, and may generate the texture of the face with respect to a particular face among the at least one face.

The reference face may include shape information of the reference face including position information of 3D points representing shape information of facial elements and edge information connecting the 3D points, and may include texture information of the reference face including image pixels representing the facial elements and a skin

The 3D unique face model generation unit may generate the shape of the unique face by deforming a shape of the reference face using a 3D registration technique based on a correspondence relationship between the shape of the face of the 3D face data and the shape of the reference face.

The 3D unique face model generation unit may generate the texture of the unique face by deforming the texture of the 3D face data through warping based on a correspondence relationship between the texture of the face of the 3D face data and a texture of the reference face.

The caricature base face model may include a shape and a texture of a 3D caricature base face model corresponding to at least one 3D unique face model generated previously and a 3D caricature generated by an expert modeler.

The 3D caricature generation unit may generate a shape of the 3D caricature by a linear superposition of a caricature sub-base of the shape depending on a shape weight vector calculated from the shape of the unique face, when the 3D caricature generation unit calculates, using an optimization technique, the shape weight vector necessary for representing the shape of the unique face by a linear superposition of unique face sub-bases of a shape of the caricature base face model.

The 3D caricature generation unit may generate a texture of the 3D caricature by a linear superposition of a caricature sub-base of the texture depending on a texture weight vector calculated from the texture of the unique face, when the 3D caricature generation unit calculates, using an optimization technique, the texture weight vector necessary for representing the texture of the unique face by a linear superposition of unique face sub-bases of texture of the caricature base face model.

The apparatus may further include a 3D caricature providing unit to provide the generated 3D caricature through at least one of caricature storage, caricature reproduction, and storage output, based on a desired point in time by the user.

In another general aspect, there is provided a method of generating a 3D caricature, the method including generating 3D face data of a user corresponding to a shape and a texture of a face of the user, generating a 3D unique face model using a shape and a texture of a unique face based on the 3D face data and a reference face, and generating a 3D caricature using the 3D unique face model and a caricature base face model.

The generating of the 3D face data may include generating the shape of the face based on a 3D position of the face using phase shifts of the face in structured light being projected, and generating the texture of the face using an image of the face taken with diffused illumination without projecting the structured light.

The generating of the 3D face data may include generating the shape of the face based on the 3D position of the face, using a triangulation method, from a correspondence relationship between at least one face, and generating the texture of the face with respect to a particular face among the at least one face.

The reference face may include shape information of the reference face including position information of 3D points representing shape information of facial elements and edge information connecting the 3D points, and may include texture information of the reference face including image pixels representing the facial elements and a skin

The generating of the 3D unique face model may include generating the shape of the unique face by deforming a shape of the reference face using a 3D registration technique based on a correspondence relationship between the shape of the face of the 3D face data and the shape of the reference face.

The generating of the 3D unique face model may include generating the texture of the unique face by deforming the texture of the 3D face data through warping based on a correspondence relationship between the texture of the face of the 3D face data and a texture of the reference face.

The caricature base face model may include a shape and a texture of a 3D caricature base face model corresponding to at least one 3D unique face model generated previously and a 3D caricature generated by an expert modeler.

The generating of the 3D caricature may include generating a shape of the 3D caricature by a linear superposition of a caricature sub-base of the shape depending on a shape weight vector calculated from the shape of the unique face, when the shape weight vector necessary for representing the shape of the unique face by a linear superposition of unique face sub-bases of a shape of the caricature base face model is calculated using an optimization technique.

The generating of the 3D caricature may include generating a texture of the 3D caricature by a linear superposition of a caricature sub-base of the texture depending on a texture weight vector calculated from the texture of the unique face, when the texture weight vector necessary for representing the texture of the unique face by a linear superposition of unique face sub-bases of texture of the caricature base face model is calculated using an optimization technique.

The method may further include providing the generated 3D caricature through at least one of caricature storage, caricature reproduction, and storage output, based on a desired point in time by the user.

Other features and aspects will be apparent from the following detailed description, the drawings, and the claims.

### BRIEF DESCRIPTION OF THE DRAWINGS

FIG. 1 is a diagram illustrating an apparatus for generating a three-dimensional (3D) caricature according to an embodiment.

FIG. 2 is a diagram illustrating a detailed configuration of an apparatus for generating a 3D caricature according to an embodiment.

FIG. 3 is a diagram illustrating the implementation of an apparatus for generating a 3D caricature according to an embodiment.

FIG. 4 is a diagram illustrating a method of generating a 3D caricature according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments of the present invention are described in detail with reference to the accompanying drawings.

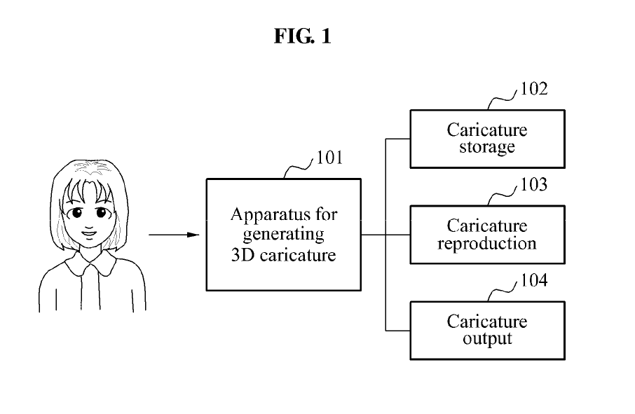

FIG. 1 is a diagram illustrating an apparatus 101 for generating a three-dimensional (3D) caricature according to an embodiment.

Referring to FIG. 1, the apparatus 101 for generating a 3D caricature may receive a face of a user. Also, in response to the face of the user being received, the apparatus 101 for generating a 3D caricature may generate 3D face data of the user corresponding to a shape and a texture of the face. Specifically, the apparatus 101 for generating a 3D caricature may generate the shape of the face using structured light and the texture from an image taken with diffused illumination. Also, the apparatus 101 for generating a 3D caricature may generate the shape and the texture of the face through at least one face.

Also, the apparatus 101 for generating a 3D caricature may generate a 3D unique face model based on the generated 3D face data and a reference face. That is, the apparatus 101 for generating a 3D caricature may generate the 3D unique face model using a shape and a texture of a unique face based on the generated 3D face data and the reference face. In this instance, the reference face may include position information of 3D points representing shape information of facial elements, edge information connecting the 3D points, and image pixels representing the facial elements and a skin

Also, the apparatus 101 for generating a 3D caricature may generate the 3D caricature using the 3D unique face model and a caricature base face model. Here, the caricature base face model may include a shape and a texture of a 3D caricature base face model corresponding to at least one 3D unique face model generated previously and a 3D caricature generated by an expert modeler.

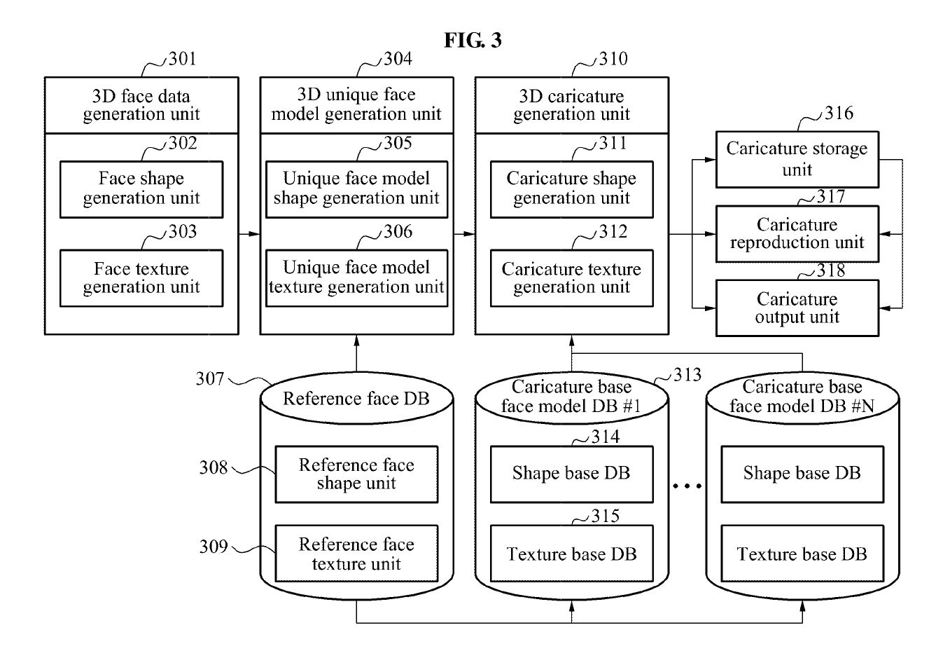

The apparatus 101 for generating a 3D caricature may provide the generated 3D caricature based on a desired point in time by the user. That is, the apparatus 101 for generating a 3D caricature may provide the 3D caricature through at least one of caricature storage 102, caricature reproduction 103, and caricature output 104, based on the desired point in time by the user. The desired point in time by the user is described in detail with reference to FIG. 3 below.

The apparatus 101 for generating a 3D caricature according to exemplary embodiment may generate 3D caricatures of various styles reflecting artistic and unique aspects intrinsic to the caricatures by generating a 3D caricature reflecting a style of an expert modeler on a face of a user.

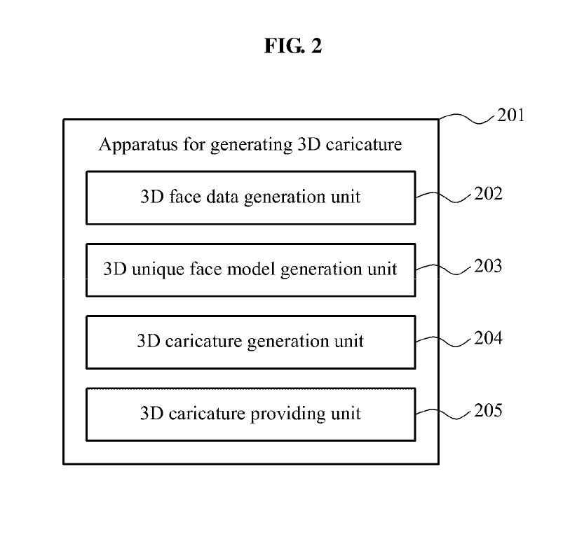

FIG. 2 is a diagram illustrating a detailed configuration of an apparatus 201 for generating a 3D caricature according to an embodiment.

Referring to FIG. 2, the apparatus 201 for generating a 3D caricature may include a 3D face data generation unit 202, a 3D unique face model generation unit 203, a 3D caricature generation unit 204, and a 3D caricature providing unit 205.

The 3D face data generation unit 202 may generate 3D face data of a user corresponding to a shape and a texture of a face of the user. Specifically, the 3D face data generation unit 202 may generate the shape of the face using structured light and the texture from an image taken with diffused illumination. That is, the 3D face data generation unit 202 may generate the shape of the face based on a 3D position using phase shifts of the face in the structured light being projected. Also, the 3D face data generation unit 202 may generate the texture of the face using a face image taken with diffused illumination without projecting structured light.

Also, the 3D face data generation unit 202 may generate the shape and the texture of the face through at least one face. In this instance, the face may correspond to a face included in at least one image. Also, the image may be obtained through a stereo method. The 3D face data generation unit 202 may generate the shape of the face based on the 3D position of the face, using a triangulation method, from a correspondence relationship between the at least one face. Here, the correspondence relationship may refer to a correspondence relationship between a pair of images including left and right images or upper and lower images obtained through a stereo method. Also, the 3D face data generation unit 202 may generate the texture of the face from an image as a reference for generating the shape of the face.

Accordingly, the 3D face data generation unit 202 may generate the shape and the texture of the face using structured light and diffused illumination or using at least one face. Also, the 3D face data generation unit 202 may generate the 3D face data of the user corresponding to the generated shape and texture of the face.

The 3D unique face model generation unit 203 may generate a 3D unique face model based on the generated 3D face data and a reference face. In this instance, the reference face may include a shape of the reference face including position information of 3D points representing shape information of facial elements, and edge information connecting the 3D points. Also, the reference face may include a texture of the reference face including image pixels representing the facial elements and a skin In this instance, the facial elements may include eyes, a nose, a mouth, a face shape, and a head shape of the face.

The 3D unique face model generation unit 203 may use a correspondence relationship between the shape of the face of the 3D face data and the shape of the reference face. The 3D unique face model generation unit 203 may deform the shape of the reference face using a 3D registration technique based on the correspondence relationship between the shape of the face of the 3D face data and the shape of the reference face. Also, the 3D unique face model generation unit 203 may generate a shape of a unique face by deforming the shape of the reference face.

Also, the 3D unique face model generation unit 203 may use a correspondence relationship between the texture of the face of the 3D face data and the texture of the reference face. The 3D unique face model generation unit 203 may deform the texture of the face of the 3D face data through warping based on the correspondence relationship between the texture of the face of the 3D face data and the texture of the reference face. Also, the 3D unique face model generation unit 203 may generate a texture of the unique face by deforming the texture of the face of the 3D face data.

Accordingly, the 3D unique face model generation unit 203 may generate the shape and the texture of the unique face based on the correspondence relationship between the shape and the texture of the face of the 3D face data and the shape and the texture of the reference face. Also, the 3D unique face model generation unit 203 may generate a 3D unique face model based on the generated shape and texture of the unique face.

The 3D caricature generation unit 204 may generate a 3D caricature using the 3D unique face model and a caricature base face model. Specifically, the 3D caricature generation unit 204 may calculate a shape weight vector through an optimization technique such as, for example, linear estimation or quadratic programming, used to compute a solution to a least square error. The shape weight vector may be necessary for representing the shape of the unique face of the 3D unique face model by a linear superposition of unique model sub-bases of the shape of the caricature base face model. Also, the 3D caricature generation unit 204 may generate a shape of the 3D caricature by a linear superposition of a caricature sub-base of the shape of the caricature base face model depending on the calculated shape weight vector. Here, the caricature base face model may include a shape and a texture of a 3D caricature base face model corresponding to at least one 3D unique face model generated previously and a 3D caricature generated by an expert modeler.

Also, the 3D caricature generation unit 204 may calculate a texture weight vector through an optimization technique such as, for example, linear estimation or quadratic programming, used to compute a solution to a least square error. The texture weight vector may be necessary for representing the texture of the unique face of the 3D unique face model by a linear superposition of unique model sub-bases of the texture of the caricature base face model. The 3D caricature generation unit 204 may generate a texture of the 3D caricature by a linear weighted superposition of a caricature sub-base of the texture of the caricature base face model depending on the calculated texture weight vector.

That is, the 3D caricature generation unit 204 may calculate, through the optimization technique, the shape weight vector and the texture weight vector necessary for representing the shape and the texture of the unique face by a linear superposition of the unique model sub-bases of the shape of the caricature base face model and a linear superposition of the unique model sub-bases of the texture of the caricature base face model. Also, the 3D caricature generation unit 204 may generate the shape and the texture of the 3D caricature by a linear weighted superposition of the caricature sub-base of the shape depending on the calculated shape weight vector and a linear weighted superposition of the caricature sub-base of the texture depending on the calculated texture weight vector.

The 3D caricature providing unit 205 may provide the generated 3D caricature based on a desired point in time by the user. That is, the 3D caricature providing unit 205 may provide the generated 3D caricature through at least one of caricature storage, caricature reproduction, and caricature output, based on the desired point in time by the user.

The caricature storage may refer to storage of the shape of the 3D caricature and the texture of the 3D caricature constituting the generated 3D caricature in a storage medium. In an example, the 3D caricature providing unit 205 may store the shape of the 3D caricature and the texture of the 3D caricature in a storage medium, for example, a hard disc.

The caricature reproduction may refer to reproduction of the 3D caricature through a visual display device by rendering the shape and the texture of the 3D caricature in the process of generating or storing the 3D caricature. In an example, the 3D caricature providing unit 205 may reproduce the 3D caricature through a visual display device, for example, a monitor, by rendering the shape and the texture of the 3D caricature.

The caricature output may refer to output of the 3D caricature through an output device after converting the shape and the texture of the 3D caricature to a suitable format for output in the process of generating or storing the 3D caricature. In an example, the 3D caricature providing unit 205 may output the shape and the texture of the 3D caricature converted to an output format through an output device, for example, a black & white/color printer, or a hologram printer or a 3D printer using stereoscopic vision.

FIG. 3 is a diagram illustrating the implementation of an apparatus for generating a 3D caricature according to an embodiment.

Referring to FIG. 3, the apparatus for generating a 3D caricature may include a 3D face data generation unit 301, a 3D unique face model generation unit 304, a 3D caricature generation unit 310, a reference face database (DB) 307, a caricature base face model DB 313, a caricature storage unit 316, a caricature reproduction unit 317, and a caricature output unit 318.

The 3D face data generation unit 301 may generate 3D face data of a user corresponding to a shape and a texture of a face of the user. The 3D face data generation unit 301 may include a face shape generation unit 302 and a face texture generation unit 303.

The face shape generation unit 302 may generate the shape of the face based on 3D position estimation of the face by measuring phase shifts from an image obtained by projection of structured light. In this instance, the image may include the face of the user. Also, the face shape generation unit 302 may generate the shape of the face based on a 3D position of the face, using a triangulation method, from a correspondence relationship between at least one face obtained through a stereo method.

The face texture generation unit 303 may generate the texture of the face using a face image taken with diffused illumination without projecting structured light. Also, the face texture generation unit 303 may generate the texture of the face from an image as a reference of the generated shape of the face, using a triangulation method.

The 3D face data generation unit 301 may generate the 3D face data of the user corresponding to the shape of the face generated by the face shape generation unit 302 and the texture of the face generated by the face texture generation unit 303.

The 3D unique face model generation unit 304 may generate a 3D unique face model based on the 3D face data and the reference face DB 307. Here, the reference face DB 307 may include a reference face shape unit 308 and a reference face texture unit 309.

The reference face shape unit 308 may include a shape of a reference face including position information of 3D points and edge information connecting the 3D points. Here, the position information of the 3D points may correspond to points representing shape information of facial elements. The facial elements may include eyes, a nose, a mouth, a face shape, and a head shape of the face.

The reference face texture unit 309 may represent a texture of the reference face including image pixels representing the facial elements and a skin

Also, the 3D unique face model generation unit 304 may include a unique face model shape generation unit 305 and a unique face model texture generation unit 306.

The unique face model shape generation unit 305 may deform the shape of the reference face, using a 3D registration technique, based on a correspondence relationship between the shape of the face of the 3D face data and the shape of the reference face of the reference face shape unit 308. That is, the unique face model shape generation unit 305 may generate a shape of a unique face by deforming the shape of the reference face based on the correspondence relationship using the 3D registration technique.

The unique face model texture generation unit 306 may deform the texture of the face of the 3D face data through warping based on a correspondence relationship between the texture of the face of the 3D face data and the texture of the reference face of the reference face texture unit 309. That is, the unique face model texture generation unit 306 may generate a texture of the unique face by deforming the texture of the face based on the correspondence relationship.

Also, the 3D unique face model generation unit 304 may generate the 3D unique face model using the shape of the unique face generated by the unique face model shape generation unit 305 and the texture of the unique face generated by the unique face model texture generation unit 306.

The 3D caricature generation unit 310 may generate a 3D caricature using the 3D unique face model and the caricature base face model DB 313. In this instance, the caricature base face model DB 313 may include a shape base DB 314 and a texture base DB 315. The caricature base face model DB 313 may include unique face sub-bases including unique faces of a plurality of users taken previously and caricature sub-bases including corresponding 3D caricatures generated by an expert modeler. Also, the caricature base face model DB 313 may include the shape base DB 314 and the texture base DB 315 through principal component analysis from the 3D caricatures generated by the expert modeler.

The caricature base face model DB 313 may be plural in a range of 1 to N in accordance with various caricature making styles of the expert modeler. Also, the caricature base face model DB 313 may generate 3D caricatures of various styles based on the number of caricature base face model DBs 313.

Also, the 3D caricature generation unit 310 may include a caricature shape generation unit 311 and a caricature texture generation unit 312.

The caricature shape generation unit 311 may calculate a shape weight vector through an optimization technique such as, for example, linear estimation or quadratic programming, used to compute a solution to a least square error. The shape weight vector may be necessary for representing the shape of the unique face of the 3D unique face model by a linear superposition of unique model sub-bases of a shape of a caricature base face model. Also, the caricature shape generation unit 311 may generate a shape of the 3D caricature by a linear weighted superposition of a caricature sub-base of the shape of the caricature base face model depending on the calculated shape weight vector.

Also, the caricature texture generation unit 312 may calculate a texture weight vector through an optimization technique such as, for example, linear estimation or quadratic programming, used to compute a solution to a least square error. The texture weight vector may be necessary for representing the texture of the unique face by a linear superposition of unique model sub-bases of the texture of the caricature base face model. The caricature texture generation unit 312 may generate a texture of the 3D caricature by a linear weighted superposition of a caricature sub-base of the texture of the caricature base face model depending on the calculated texture weight vector.

Also, the 3D caricature generation unit 310 may generate the 3D caricature using the shape of the 3D caricature generated by the caricature shape generation unit 311 and the texture of the 3D caricature generated by the caricature texture generation unit 312. The caricature storage unit 316 may store the shape and the texture of the 3D caricature constituting the 3D caricature in a storage medium.

The caricature reproduction unit 317 may render the shape and the texture of the 3D caricature in the process of generating the 3D caricature or storing the 3D caricature, and may reproduce the 3D caricature through a visual display device.

The caricature output unit 318 may convert the shape and the texture of the 3D caricature to a suitable format for output in the process of generating or storing the 3D caricature, and may output the 3D caricature through an output device.

The user may be provided with the generated 3D caricature through at least one of the caricature storage unit 316, the caricature reproduction unit 317, and the caricature output unit 318, based on a desired point in time by the user.

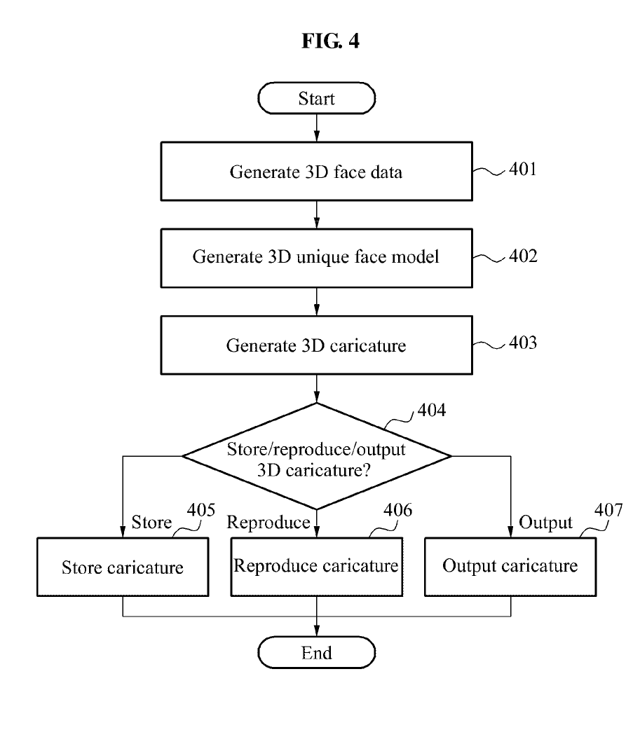

FIG. 4 is a diagram illustrating a method of generating a 3D caricature according to an embodiment.

Referring to FIG. 4, in 401, an apparatus for generating a 3D caricature may generate a shape of a face using structured light and a texture from an image taken with diffused illumination. Also, the apparatus for generating a 3D caricature may generate 3D face data of a user corresponding to the generated shape and texture of the face. Specifically, the apparatus for generating a 3D caricature may generate the shape of the face based on a 3D position of the face using phase shifts of the face in the structured light being projected. Also, the apparatus for generating a 3D caricature may generate the texture of the face using a face image taken with diffused illumination without projecting structured light.

Also, the apparatus for generating a 3D caricature may generate the shape and the texture of the face through at least one face. Also, the apparatus for generating a 3D caricature may generate the 3D face data of the user corresponding to the generated shape and texture of the face. That is, the apparatus for generating a 3D caricature may generate the shape of the face based on the 3D position of the face, using a triangulation method, from a correspondence relationship between the at least one face. Also, the apparatus for generating a 3D caricature may generate the texture of the face from an image as a reference for generating the shape of the face.

According, the apparatus for generating a 3D caricature may generate the 3D face data corresponding to the generated shape and texture of the face.

In 402, the apparatus for generating a 3D caricature may generate a 3D unique face model based on the generated 3D face data and a reference face. The apparatus for generating a 3D caricature may generate a shape of a unique face by deforming a shape of the reference face using a 3D registration technique based on a correspondence relationship between the shape of the face and the shape of the reference face. Also, the apparatus for generating a 3D caricature may generate a texture of the unique face by deforming the texture of the face of the 3D face data through warping based on a correspondence relationship between the texture of the face and a texture of the reference face. Accordingly, the apparatus for generating a 3D caricature may generate a 3D unique face model based on the generated shape and texture of the unique face.

In 403, the apparatus for generating a 3D caricature may generate a 3D caricature using the 3D unique face model and a caricature base face model. The apparatus for generating a 3D caricature may calculate a shape weight vector and a texture weight vector necessary for representing the shape and the texture of the unique face by a linear superposition of unique model sub-bases of the shape and the texture of the caricature base face model. Also, the apparatus for generating a 3D caricature may generate the 3D caricature by a linear weighted superposition of the sub-base of the shape depending on the calculated shape weight vector, and a linear weighted superposition of the sub-base of the texture depending on the calculated texture weight vector.

In 404, the apparatus for generating a 3D caricature may provide the generated 3D caricature through at least one of caricature storage, caricature reproduction, and caricature output, based on a desired point in time by the user.

In 405, the apparatus for generating a 3D caricature may store the shape of the 3D caricature and the texture of the 3D caricature constituting the generated 3D caricature in a storage medium.

In 406, the apparatus for generating a 3D caricature may render the shape and the texture of the 3D caricature in the process of generating the 3D caricature or storing the 3D caricature, and may reproduce the 3D caricature through a visual display device.

In 407, the apparatus for generating a 3D caricature may convert the shape and the texture of the 3D caricature to a suitable format for output in the process of generating the 3D caricature or storing the 3D caricature, and may output the 3D caricature through an output device.

According to an exemplary embodiment, the apparatus for generating a 3D caricature may generate a 3D caricature reflecting a style of an expert modeler specializing in a face of a user, so that 3D caricatures of various styles may be generated by effectively reflecting artistic and unique traits inherent to a caricature.

The methods according to the exemplary embodiments may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating a three-dimensional (3D) caricature, the apparatus comprising:
a 3D face data generation unit to generate 3D face data of a user corresponding to a shape and a texture of a face of the user;
a 3D unique face model generation unit to generate a 3D unique face model using a shape and a texture of a unique face based on the 3D face data and a reference face; and
a 3D caricature generation unit to generate a 3D caricature using the 3D unique face model and a caricature base face model.

2. The apparatus of claim 1, wherein the 3D face data generation unit generates the shape of the face based on a 3D position of the face using phase shifts of the face in structured light being projected, and generates the texture of the face using an image of the face taken with diffused illumination without projecting the structured light.

3. The apparatus of claim 1, wherein the 3D face data generation unit generates the shape of the face based on the 3D position of the face, using a triangulation method, from a correspondence relationship between at least one face, and generates the texture of the face with respect to a particular face among the at least one face.

4. The apparatus of claim 1, wherein the reference face includes:
shape information of the reference face including position information of 3D points representing shape information of facial elements, and edge information connecting the 3D points, and
texture information of the reference face including image pixels representing the facial elements and a skin.

5. The apparatus of claim 1, wherein the 3D unique face model generation unit generates the shape of the unique face by deforming a shape of the reference face using a 3D registration technique based on a correspondence relationship between the shape of the face of the 3D face data and the shape of the reference face.

6. The apparatus of claim 1, wherein the 3D unique face model generation unit generates the texture of the unique face by deforming the texture of the 3D face data through warping based on a correspondence relationship between the texture of the face of the 3D face data and a texture of the reference face.

7. The apparatus of claim 1, wherein the caricature base face model includes a shape and a texture of a 3D caricature base face model corresponding to at least one 3D unique face model generated previously and a 3D caricature generated by an expert modeler.

8. The apparatus of claim 1, wherein the 3D caricature generation unit generates a shape of the 3D caricature by a linear superposition of a caricature sub-base of the shape depending on a shape weight vector calculated from the shape of the unique face and a caricature sub-base of the shape, when the 3D caricature generation unit calculates, using an optimization technique, the shape weight vector necessary for representing the shape of the unique face by a linear superposition of unique face sub-bases of a shape of the caricature base face model.

9. The apparatus of claim 1, wherein the 3D caricature generation unit generates a texture of the 3D caricature by a linear superposition of a caricature sub-base of the texture depending on a texture weight vector calculated from the texture of the unique face and a caricature sub-base of the texture, when the 3D caricature generation unit calculates, using an optimization technique, the texture weight vector necessary for representing the texture of the unique face by a linear superposition of unique face sub-bases of texture of the caricature base face model.

10. The apparatus of claim 1, further comprising:
a 3D caricature providing unit to provide the generated 3D caricature through at least one of caricature storage, caricature reproduction, and storage output, based on a desired point in time by the user.

11. A method of generating a three-dimensional (3D) caricature, the method comprising:
generating 3D face data of a user corresponding to a shape and a texture of a face of the user;
generating a 3D unique face model using a shape and a texture of a unique face based on the 3D face data and a reference face; and
generating a 3D caricature using the 3D unique face model and a caricature base face model.

12. The method of claim 11, wherein the generating of the 3D face data comprises:
generating the shape of the face based on a 3D position of the face using phase shifts of the face in structured light being projected; and
generating the texture of the face using an image of the face taken with diffused illumination without projecting the structured light.

13. The method of claim 11, wherein the generating of the 3D face data comprises:
generating the shape of the face based on the 3D position of the face, using a triangulation method, from a correspondence relationship between at least one face; and
generating the texture of the face with respect to a particular face among the at least one face.

14. The method of claim 11, wherein the reference face includes:
shape information of the reference face including position information of 3D points representing shape information of facial elements, and edge information connecting the 3D points, and texture information of the reference face including image pixels representing the facial elements and a skin

15. The method of claim 11, wherein the generating of the 3D unique face model comprises generating the shape of the unique face by deforming a shape of the reference face using a 3D registration technique based on a correspondence relationship between the shape of the face of the 3D face data and the shape of the reference face.

16. The method of claim 11, wherein the generating of the 3D unique face model comprises generating the texture of the unique face by deforming the texture of the 3D face data through warping based on a correspondence relationship between the texture of the face of the 3D face data and a texture of the reference face.

17. The method of claim 11, wherein the caricature base face model includes a shape and a texture of a 3D caricature base face model corresponding to at least one 3D unique face model generated previously and a 3D caricature generated by an expert modeler.

18. The method of claim 11, wherein the generating of the 3D caricature comprises generating a shape of the 3D caricature by a linear superposition of a caricature sub-base of the shape depending on a shape weight vector calculated from the shape of the unique face and a caricature sub-base of the shape, when the shape weight vector necessary for representing the shape of the unique face by a linear superposition of unique face sub-bases of a shape of the caricature base face model is calculated using an optimization technique.

19. The method of claim 11, wherein the generating of the 3D caricature comprises generating a texture of the 3D caricature by a linear superposition of a caricature sub-base of the texture depending on a texture weight vector calculated from the texture of the unique face and a caricature sub-base of the texture, when the texture weight vector necessary for representing the texture of the unique face by a linear superposition of unique face sub-bases of texture of the caricature base face model is calculated using an optimization technique.

20. The method of claim 11, further comprising:
providing the generated 3D caricature through at least one of caricature storage, caricature reproduction, and storage output, based on a desired point in time by the user.
